(19) United States
(12) Patent Application Publication
(10) Pub. No.: US 2025/0387986 A1
(43) Pub. Date: Dec. 25, 2025

(54) METHOD FOR MANUFACTURING RESIN MATRIX COMPOSITE PART BY NEAR-NET-SHAPE MOLDING OF SHORT-CUT FIBER PREPREG

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (CN); Weiwei JIAO, Taiyuan (CN); Guizhe ZHAO, Taiyuan (CN); Dingding BAI, Taiyuan (CN)

(21) Appl. No.: 19/305,682

(22) Filed: Aug. 20, 2025

(30) Foreign Application Priority Data
May 19, 2025 (CN) 202510642687.7

(51) Int. Cl. B29C 70/30; B29C 37/00; B29C 70/34; B29C 70/54; B29K 63/00; C08J 5/24; G05B 17/02

(52) U.S. Cl. CPC B29C 70/302; B29C 37/00; B29C 70/34; B29C 70/543; C08J 5/243; G05B 17/02; B29C 2037/903; B29K 2063/00; C08J 2363/00

(57) ABSTRACT

A method for manufacturing a resin matrix composite part by near-net-shape molding of a short-cut fiber prepreg is provided. A part simulation model is established. A cavity-core mold is fabricated according to the resin matrix composite part. A preset amount of the short-cut fiber prepreg is determined according to a dimension of the resin matrix composite part. The short-cut fiber prepreg with the preset amount is cut into a plurality of prepreg sections according to a cavity size of the cavity-core mold. The prepreg sections are laid in a stepped manner. The cavity-core mold is heated and subject to a mold closing pressure. The near-net-shape molding is performed for a preset time, and then demolding and post-processing are performed to obtain the resin matrix composite part with a required accuracy.

### CROSS-REFERENCE TO RELATED APPLICATIONS

This application claims the benefit of priority from Chinese Patent Application No. 202510642687.7, filed on May 19, 2025. The content of the aforementioned application, including any intervening amendments made thereto, is incorporated herein by reference in its entirety.

### TECHNICAL FIELD

This application relates to compression molding of resin matrix composite parts, and more particularly to a method for manufacturing a resin matrix composite part by near-net-shape molding of a short-cut fiber prepreg.

### BACKGROUND

Short-cut fiber prepreg is a semi-finished product in which a reinforcing-phase fiber is impregnated in a matrix-phase resin. The matrix phase is generally selected from epoxy resin, phenolic resin, unsaturated polyester resin, etc. The reinforcing phase is generally selected from short-cut carbon fiber, short-cut glass fiber, short-cut aramid fiber, short-cut basalt fiber, etc. Compared with long fiber prepreg and continuous fiber prepreg, short-cut fiber prepreg has higher fluidity and formability, which is more suitable for the manufacture of complex shaped parts, and has better mechanical properties. The quality and performance of the final composite parts depend on the molding process. Therefore, based on the urgent demand for lightweight and high-quality resin matrix composite parts in various fields today, it is urgent to develop prepreg near-net-shape molding technology.

Compression molding is a process in which powdered, granular, or fibrous plastic is placed into a mold cavity at a molding temperature, and then the mold is closed and pressurized to achieve molding and curing. It is commonly used for manufacturing parts or products of various shapes, which is efficient, precise, and suitable for mass production. The main process parameters for compression molding of resin matrix composite parts include molding temperature, molding pressure, and molding time. These parameters have a crucial impact on the molding process and the quality of the final product. At present, defects in compression-molded resin matrix composite parts mainly include delamination, pores, voids, resin-rich, poor glue, debonding, looseness, deformation, and weak adhesion, where the delamination accounts for the highest proportion, exceeding 50%, and the pores and voids also account for a high proportion. Delamination refers to poor interlayer bonding caused by insufficient pressure and uneven temperature during the manufacturing process. Pores and voids not only affect the quality and appearance, but also lead to reduced mechanical strength of the product. This is mainly due to the incomplete discharge of entrained air, hygroscopic water, volatile solvents, etc., resulting in pores and voids inside the material. Resin-rich refers to excessive resin, while resin-poor refers to insufficient resin, which are usually caused by improper mold design or operation. Debonding refers to the insufficient bond between the fiber and the resin, which may be caused by incomplete curing or improper temperature control. Looseness refers to the loose internal structure of the material, which may be caused by insufficient pressure or improper temperature control during the curing process. Deformation and weak adhesion refer to changes in the shape of the part or insufficient interlayer bonding, which may be caused by unreasonable mold design or improper operation. These defects ultimately result in the deterioration of the mechanical properties of the molded part.

At present, the control of temperature and pressure in the manufacture of prepreg-based resin matrix composite parts commonly relies on manual experience and static settings, which fails to flexibly respond to changes in complex molds and different resin materials, resulting in uneven temperature distribution and unstable pressure, thus affecting the quality and mechanical properties of molded parts. Therefore, the exploration of molding processes for complex parts and thick resin matrix composite parts has become one of the important directions at present.

Overall, the development of an economical, efficient, and high-quality near-net-shape molding process for short-cut fiber prepregs is of great significance and application value.

### SUMMARY

An object of the disclosure is to provide a method for manufacturing a resin matrix composite part by near-net-shape molding of a short-cut fiber prepreg, so as to solve the problem in the prior art that the control of temperature and pressure in a compression molding process of resin matrix composite prepreg parts relies only on manual experience and static settings, leading to degraded mechanical properties of final parts.

In order to achieve the above object, the following technical solutions are adopted.

This application provides a method for manufacturing a resin matrix composite part by near-net-shape molding of a short-cut fiber prepreg, comprising:
(1) establishing a simulation model of the resin matrix composite part; performing, by a reactive compression molding module in a plastic molding simulation software, coupling simulation between temperature and pressure in a near-net-shape molding process to obtain a temperature-pressure coupling relationship; and determining an optimal mold closing window by simulating a flow-front temperature distribution of the short-cut fiber prepreg under varying mold closing pressures in combination with a curing reaction rate of a resin matrix of the short-cut fiber prepreg to predict a porosity of a manufactured resin matrix composite part;
(2) fabricating a cavity-core mold according to the resin matrix composite part, wherein a volume of a cavity of the cavity-core mold is calculated based on a volume compensation formula, expressed as:

$${V}_{m} = \frac{{V}_{p}}{1 - {S}_{v}} ,$$

wherein Vₘ is the volume of the cavity of the cavity-core mold, Vₚ is a volume of the resin matrix composite part, and Sᵥ is a volumetric shrinkage rate of the resin matrix of the short-cut fiber prepreg;
(3) calculating a preset amount m of the short-cut fiber prepreg through the following equation:

$$m = {V}_{m} \times ρ \times Ke ,$$

wherein ρ is a density of the short-cut fiber prepreg, and Ke is a loss coefficient ranging from 1.02 to 1.10;
(4) cutting the short-cut fiber prepreg with the preset amount according to a dimension of the cavity of the cavity-core mold to obtain a plurality of prepreg sections, wherein a dimension of one of the plurality of prepreg sections corresponding to a portion of the resin matrix composite part with a largest cross-section is 60-80% of a dimension of the cavity corresponding to the portion of the resin matrix composite part with the largest cross-section, and remaining prepreg sections among the plurality of prepreg sections corresponding to the rest of the resin matrix composite part are decreasing layer by layer in dimension; and laying the plurality of prepreg sections in a stepped manner to facilitate gas discharge during the near-net-shape molding process;
(5) heating the cavity-core mold to a temperature 10° C. to 20° C. lower than a molding temperature of the near-net-shape molding process, placing the plurality of prepreg sections laid in the stepped manner into the cavity-core mold, and deploying temperature sensors and first pressure sensors on surfaces of the plurality of prepreg sections in contact with the cavity or the core of the cavity-core mold and a central position of the plurality of prepreg sections;
(6) heating the cavity-core mold and simultaneously applying a mold closing pressure in the optimal closing window corresponding to a minimal predicted porosity of the manufactured resin matrix composite part obtained in step (1) to the cavity-core mold, monitoring pressure data by the first pressure sensors in real time; and if the flow-front temperature distribution of the plurality of prepreg sections is uniform and resin overflow occurs at an edge of the cavity-core mold, stepwise releasing a pressure which is no more than 10% of a molding pressure, pressurizing the cavity-core mold to the molding pressure under the mold closing pressure, and performing mold clamping by using an automatic control system, wherein the molding pressure is obtained based on the molding temperature and the temperature-pressure coupling relationship;
(7) performing the near-net-shape molding process at the molding pressure and the molding temperature; and simultaneously monitoring, by the temperature sensors and the first pressure sensors, the surfaces of the plurality of prepreg sections in contact with the cavity or the core of the cavity-core mold and the central position of the plurality of prepreg sections in real time, recording a temperature-time curve, and performing temperature adjustment in time such that temperature differentials between the central position and the surfaces of the plurality of prepreg sections in contact with the cavity or the core of the cavity-core mold are maintained within 3° C.; and monitoring the temperature-pressure coupling relationship at the same time; and
(8) after the near-net-shape molding process is performed for a molding time, performing demolding and post-processing to obtain the resin matrix composite part.

In some embodiments, characterization of the resin matrix, selection of a curing reaction model of the resin matrix and a length of a short-cut fiber of the short-cut fiber prepreg, and setting of temperature and pressure parameters are performed in the plastic molding simulation software.

In some embodiments, in step (1), the resin matrix of the short-cut fiber prepreg is selected from the group consisting of an epoxy resin, a phenolic resin, an unsaturated polyester resin, and a combination thereof; and the short-cut fiber of the short-cut fiber prepreg is selected from the group consisting of a short-cut carbon fiber, a short-cut glass fiber, a short-cut aramid fiber, a short-cut basalt fiber, and a combination thereof.

In some embodiments, step (1) further comprises:
obtaining a gelation temperature, a curing temperature, and a curing time of the resin matrix of the short-cut fiber prepreg by testing;
wherein the gelation temperature, the curing temperature, and the curing time of the resin matrix are obtained using a differential scanning calorimeter, a rheometer, or a flat-plate microknife fiber drawing method; and
determining the molding temperature to be within a range from the curing temperature of the resin matrix to the curing temperature plus 20° C., and determining the curing time as the molding time.

In some embodiments, in step (2), the cavity-core mold is made of steel, aluminum alloy, or ceramic.

In some embodiments, the cavity-core mold is provided with a positioning pin, a second pressure sensor, and a displacement sensor; and
the positioning pin is configured to ensure thickness uniformity of the resin matrix composite part; the second pressure sensor is configured for real-time pressure monitoring within the cavity; and the displacement sensor is configured to monitor a mold closing position and a resin overflow amount in real time.

In some embodiments, in step (6), the mold closing pressure is 0.1-0.5 MPa.

In some embodiments, in step (4), the one of the plurality of prepreg sections corresponding to the portion of the resin matrix composite part with the largest cross-section is arranged equidistant from all edges of a cross-section of the cavity corresponding to the portion of the resin matrix composite part with the largest cross-section.

Compared to the prior art, the present disclosure has the following beneficial effects.
(1) A plastic molding simulation software (e.g., Autodesk Moldflow®) is utilized to simulate a flow behavior of a short-cut fiber prepreg during compression molding process, thereby reducing trial molding iterations and material waste, while guiding and accelerating the determination of process parameters for short-cut fiber prepreg molding.
(2) The plurality of prepreg sections is laid in a stepped manner to facilitate air discharge during the compression molding process, thereby avoiding the occurrence of pores and voids in the molded parts.
(3) A multi-channel tester is used to precisely control the process parameters. Temperature and pressure sensors are mounted at critical positions of the mold to monitor temperature and pressure changes in the cavity in real time, enabling precise determination of mold closing timing. By virtue of these meters, the mold closing operation is precisely executed at an optimal moment when the mold closing timing is reached, thereby improving product quality and reducing production cycle and energy consumption.
(4) Parts manufactured by the method of the present disclosure exhibit reduced porosity, resulting in superior overall performance, especially mechanical properties including tensile strength and bending strength. This method is particularly suitable for preparation of thick-wall and high-quality composite parts.

### BRIEF DESCRIPTION OF THE DRAWINGS

The accompanying drawings, which are incorporated into and constitute a part of this specification, are intended to illustrate the embodiments of the disclosure, and are used for explaining the principles of the disclosure in conjunction with the specification.

In order to illustrate the technical solutions in the embodiments of the present disclosure or in the prior art more clearly, the drawings needed in the description of embodiments or the prior art will be briefly introduced below. Obviously, for those of ordinary skill in the art, other drawings can be obtained based on these drawings without exerting creative efforts.

FIG. 1 is a flow chart of a method for manufacturing a resin matrix composite part by near-net-shape molding of a short-cut fiber prepreg in accordance with an embodiment of the present disclosure;

FIG. 2 shows flow-front temperature distribution simulated by Autodesk Moldflow® in Example 1 of the present disclosure;

FIG. 3 shows porosity distribution of a molded part in Example 1 of the present disclosure;

FIG. 4 a schematic diagram of multi-channel temperature sensors in Example 1 of the present disclosure;

FIG. 5 shows a time-temperature graph obtained by testing with the multi-channel temperature sensors in Example 1 of the present disclosure; and

FIG. 6 is a schematic diagram of short-cut fiber prepregs laid in a staggered manner in the prior art.

### DETAILED DESCRIPTION OF EMBODIMENTS

In order to understand the above objects, features, and beneficial effects of the present disclosure more clearly, the technical solutions of the present disclosure will be further described below. It should be noted that, as long as there is no contradiction, the embodiments of the present disclosure and the features in the embodiments can be combined with each other.

Many specific details are set forth in the following description to facilitate the understanding of the present disclosure, but the present disclosure can also be implemented in other ways different from those described herein. Obviously, described herein are merely some embodiments of the present disclosure, rather than all embodiments.

The embodiments of the present disclosure are described in detail below.

### EXAMPLE 1

Provided herein was a method for manufacturing a resin matrix composite part by near-net-shape molding of an epoxy resin short-cut fiber prepreg, which included the following steps.

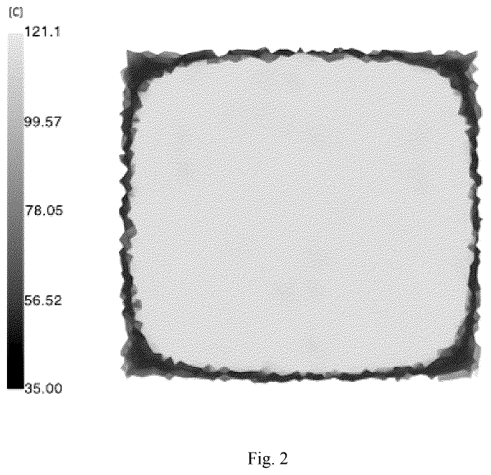

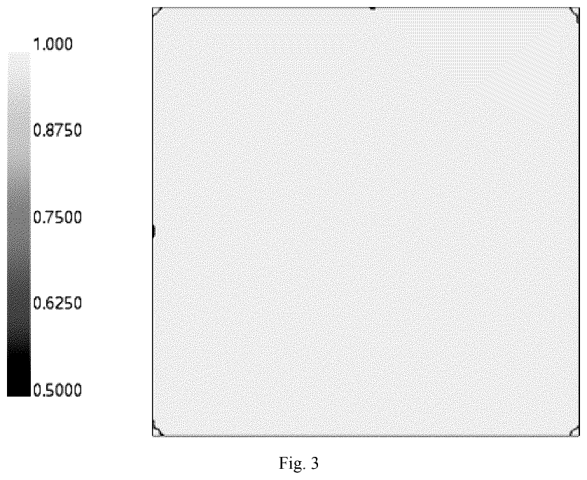

(SI) The resin matrix composite part to be manufactured by near-net-shape molding of a short-cut fiber prepreg was a square plate-type with dimensions of 300×300×4 cm. A flat plate simulation model was established based on the part and imported into a plastic molding simulation software (Autodesk Moldflow™ software). Epoxy resin was defined as the resin matrix of the short-cut fiber prepreg, and an autocatalytic model was selected. A mesh grid divide was generated. An initial temperature of the short-cut fiber prepreg was set to 25° C., and a molding pressure was set to 5-20 MPa. The above settings were determined for the following reasons. Firstly, dimensions of the target part were 300×300×4 mm, and a prepreg layer thickness was about 4 mm, which eliminated the need for high pressure to prevent fiber dislocation. Secondly, the epoxy resin with high fluidity required moderate pressure to facilitate gas discharge. Thirdly, molding pressure depends on prepreg performance, part thickness, and part structure, and the molding pressure for the epoxy resin prepreg typically ranges between 5-20 MPa. Coupling simulation between temperature and pressure in the molding process was performed to obtain a temperature-pressure coupling relationship. A flow-front temperature distribution of the short-cut fiber prepreg under varying mold closing pressures was simulated in combination with the curing reaction rate of the epoxy resin matrix to predict porosity of a manufactured resin matrix composite part. Comparative analyses demonstrated that at a mold closing pressure of 0.15 MPa, the flow-front temperature distribution was uniform, and a minimal porosity of the molded part was achieved. Thus, 0.15 MPa was identified as the optimal mold closing pressure. The flow-front temperature distribution under the mold closing pressure of 0.15 MPa and the porosity distribution predicted by observing the flow-front temperature distribution in combination with the curing reaction rate were shown in FIGS. 2 and 3, respectively. The flow-front temperature refers to a peak temperature attained at the advancing material boundary during near-net-shape molding, which is crucial for controlling the molding process and ensuring the product quality. The flow-front temperature directly influences the fluidity and curing reaction of the material, and further influences the density and performance of the molded part. As shown in FIG. 2, under the mold closing pressure of 0.15 MPa, the flow-front temperature had a uniform distribution and continuously increased, and the prepreg exhibited uniform diffusion to all surroundings.

It can be seen from FIG. 3 that pores were predominantly concentrated at four corners of the part. This phenomenon occurred because these regions are the last to be filled with resin where the pressure transmission is relatively inadequate. As a result, gas discharge cannot be effectively achieved after the local viscosity increases.

(SII) The prepreg was composed of epoxy resin and short-cut carbon fiber, where the short-cut carbon fiber had a length of 25 mm, and a content of epoxy resin is 55 wt. %. A volumetric shrinkage rate Vₛ of the epoxy resin was calculated as 3% through the following equation:

$${V}_{s} = ( {V}_{0} - {V}_{C} ) \div {V}_{0} \times 1 \; 00 \% .$$

In the above equation, V₀ was a volume of the epoxy resin matrix in an uncured state, and V_{C} was a volume of the epoxy resin matrix in a fully cured state. The target part was a square plate-type part with dimensions of 300×300×4 mm and a volume of 360,000 mm³. A 45# steel cavity-core mold was utilized as the mold. A dimension of a cavity of the mold was calculated as 303.10×303.10×4.05 mm with a volume of 372,072 mm³ through a volume compensation formula, expressed as:

$${V}_{m} = \frac{{V}_{p}}{1 - {S}_{v}} .$$

In the above equation, Vₘ was the volume of the mold cavity, Vₚ was a volume of the target part, Sᵥ was the volumetric shrinkage rate of the resin matrix. The mold cavity was subjected to surface polishing according to the surface accuracy and dimensional accuracy requirements of the target part, and a positioning pin was arranged in the mold to ensure uniform part thickness. A pressure sensor was installed in the mold to monitor cavity pressure in real time. A displacement sensor was installed in the mold to monitor the mold closure position and resin overflow amount in real time.

(SIII) A preset amount m of the short-cut fiber prepreg was calculated through the following equation:

$$m = {V}_{m} \times ρ \times Ke .$$

In the above equation, Vₘ was the volume of the cavity of 372,072 mm³, and ρ was a density of the short-cut fiber prepreg of 1.47 g/cm³, and Ke was a loss coefficient. According to common knowledge in prepreg compression molding, the loss coefficient Ke was 1.02-1.05 for flat plate-type parts and 1.05-1.10 for complex parts. Since the target part was a flat plate-type part with moderate volume, the loss coefficient of 1.02 was selected. The preset amount m of the short-cut fiber prepreg was determined to be 557.90 g.

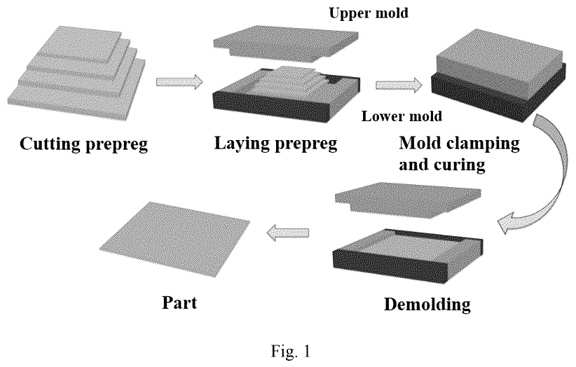

(SIV) The prepreg with the preset amount 557.90 g was cut according to the dimension of the cavity to obtain a plurality of prepreg sections, where a dimension of one prepreg section that was determined as the lowermost layer among the plurality of prepreg sections was 80% of the dimension of the lowermost layer of the cavity, and remaining prepreg sections among the plurality of prepreg sections corresponding to the rest of the target part were decreasing in dimension layer by layer. The plurality of prepreg sections were laid in a stepped manner as shown in FIG. 1, thereby facilitating gas discharge during the near-net-shape molding process.

(SV) A gelation temperature, a curing temperature, and a curing time of the epoxy resin matrix were determined using a differential scanning calorimeter. The gelation temperature was 110° C., the curing temperature was 120° C., and the curing time was 20 min. Based on these parameter values, the molding temperature was determined to be 120° C., and the molding time was determined to be 20 min. The molding pressure of 5 MPa was obtained based on the curing temperature of 120° C. and the temperature-pressure coupling relationship obtained in step (SI). Thus, all process parameters for near-net-shape molding were determined.

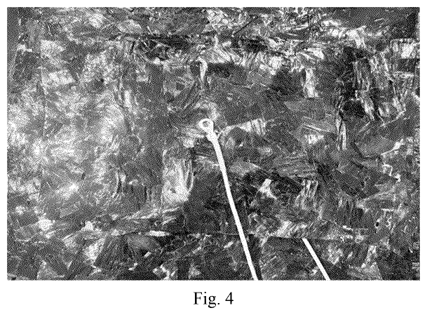

(SVI) The mold was heated to 110° C. The plurality of prepreg sections laid in the stepped manner were placed into the mold such that the maximum-dimension layer (i.e., the prepreg section that was determined as the lowermost layer) was arranged equidistant from all edges of the mold. Temperature and pressure sensors were arranged on each surface and a central position of each of the plurality of prepreg sections, as shown in FIG. 4. It can be seen from FIG. 4 that the method of the present disclosure enables comprehensive monitoring of temperature changes in different regions during the molding process.

(SVII) The mold was heated, and the mold closing pressure of 0.15 MPa was simultaneously applied to the mold. Pressure data was monitored in real time. If the flow-front temperature distribution was uniform and resin overflow occurs at the edge of the mold, the pressure was stepwise reduced to 4.6 MPa, then increased to the molding pressure of 5 MPa. Mold clamping was performed by using an automatic control system.

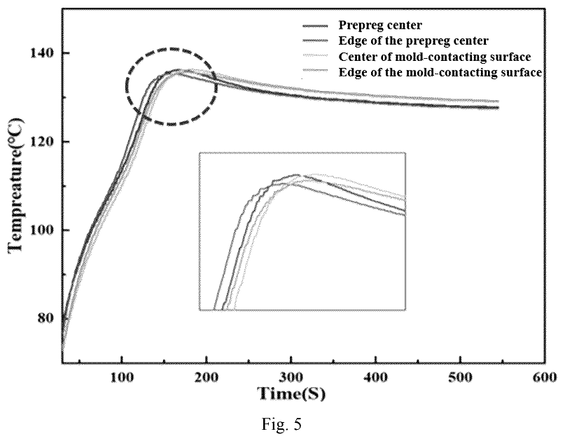

(SVIII) The near-net-shape molding was performed at 5 MPa and 120° C. for 20 min. The central position of the plurality of prepreg sections and all surfaces of the plurality of prepreg sections in contact with the cavity were monitored in real time, and a temperature-time curve was recorded. Temperature adjustment was performed in time such that temperature differentials between the central position and the surfaces of the plurality of prepreg sections in contact with the cavity were maintained within 3° C., as shown in FIG. 5. It can be seen from FIG. 5 that the present disclosure can achieve precise control of the temperature field during the molding process.

(SIX) After the near-net-shape molding was completed, demolding and post-processing were performed, so as to obtain the resin matrix composite part with a required accuracy.

Defects induced by the molding process ultimately resulted in degradation of mechanical properties in molded parts. Accordingly, quality of the part provided herein was evaluated based on mechanical properties.

The part obtained in Example 1 exhibited bending strength of 474.62 MPa and tensile strength of 269.05 MPa.

### EXAMPLE 2

The manufacturing method provided herein was basically the same as that in Example 1, except that the molding temperature was 130° C.

The part obtained in Example 2 exhibited bending strength of 566.81 MPa and tensile strength of 279.61 MPa.

### COMPARATIVE EXAMPLE 1

The manufacturing method provided herein was basically the same as that in Example 1, except that the molding time was 30 min.

The part obtained in Comparative Example 1 exhibited bending strength of 433.04 MPa and tensile strength of 197.94 MPa.

### COMPARATIVE EXAMPLE 2

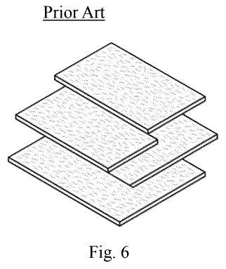

The manufacturing method provided herein was basically the same as that in Example 1, except that the plurality of prepreg sections were laid in a staggered manner as shown in FIG. 6, instead of a stepped manner.

The part obtained in Comparative Example 2 exhibited bending strength of 415.14 MPa and tensile strength of 167.46 MPa.

### COMPARATIVE EXAMPLE 3

The manufacturing method provided herein was basically the same as that in Example 1, except that the molding pressure was 10 MPa.

The part obtained in Comparative Example 3 exhibited bending strength of 522.39 MPa and tensile strength of 202.55 MPa.

Comparison between Examples 1-2 and Comparative Examples 1-3 demonstrated significant impact of process parameters on properties of final parts during compression molding of the short-cut fiber prepreg. Inappropriate molding pressure may lead to resin accumulation or loss; inappropriate molding temperature may cause uneven curing of the prepreg; and inappropriate molding time may result in insufficient curing or over-curing of the prepreg. It can be concluded that the compression molding process of the present disclosure results in manufactured parts with enhanced mechanical properties and improved quality.

The embodiments described above are merely illustrative of the present application, and are intended to enable those skilled in the art to understand or implement the present disclosure, instead of limiting the scope of the present application. Although detailed descriptions have been made with reference to the above embodiments, various modifications and replacements can still be made to the technical solutions recited in the above embodiments. It should be understood that those modifications and replacements made by those of ordinary skill in the art without departing from the spirit of the disclosure shall fall within the scope of the disclosure defined by the appended claims.

What is claimed is:

1. A method for manufacturing a resin matrix composite part by near-net-shape molding of a short-cut fiber prepreg, comprising:
(1) establishing a simulation model of the resin matrix composite part; performing, by a reactive compression molding module in a plastic molding simulation software, coupling simulation between temperature and pressure in a near-net-shape molding process to obtain a temperature-pressure coupling relationship; and determining an optimal mold closing window by simulating a flow-front temperature distribution of the short-cut fiber prepreg under varying mold closing pressures in combination with a curing reaction rate of a resin matrix of the short-cut fiber prepreg to predict a porosity of a manufactured resin matrix composite part;
(2) fabricating a cavity-core mold according to the resin matrix composite part, wherein a volume of a cavity of the cavity-core mold is calculated based on a volume compensation formula, expressed as:
$${V}_{m} = \frac{{V}_{p}}{1 - {S}_{v}} ,$$
wherein Vₘ is the volume of the cavity of the cavity-core mold, Vₚ is a volume of the resin matrix composite part, and Sᵥ is a volumetric shrinkage rate of the resin matrix of the short-cut fiber prepreg;
(3) calculating a preset amount m of the short-cut fiber prepreg through the following equation:
$$m = {V}_{m} \times ρ \times Ke ,$$
wherein ρ is a density of the short-cut fiber prepreg, and Ke is a loss coefficient ranging from 1.02 to 1.10;
(4) cutting the short-cut fiber prepreg with the preset amount according to a dimension of the cavity of the cavity-core mold to obtain a plurality of prepreg sections, wherein a dimension of one of the plurality of prepreg sections corresponding to a portion of the resin matrix composite part with a largest cross-section is 60-80% of a dimension of the cavity corresponding to the portion of the resin matrix composite part with the largest cross-section, and remaining prepreg sections among the plurality of prepreg sections corresponding to the rest of the resin matrix composite part are decreasing layer by layer in dimension; and laying the plurality of prepreg sections in a stepped manner to facilitate gas discharge during the near-net-shape molding process;
(5) heating the cavity-core mold to a temperature 10° C. to 20° C. lower than a molding temperature of the near-net-shape molding process, placing the plurality of prepreg sections laid in the stepped manner into the cavity-core mold, and deploying temperature sensors and first pressure sensors on surfaces of the plurality of prepreg sections in contact with the cavity or the core of the cavity-core mold and a central position of the plurality of prepreg sections;
(6) heating the cavity-core mold and simultaneously applying a mold closing pressure in the optimal closing window corresponding to a minimal predicted porosity of the manufactured resin matrix composite part obtained in step (1) to the cavity-core mold, monitoring pressure data by the first pressure sensors in real time; and if the flow-front temperature distribution of the plurality of prepreg sections is uniform and resin overflow occurs at an edge of the cavity-core mold, stepwise releasing a pressure which is no more than 10% of a molding pressure, pressurizing the cavity-core mold to the molding pressure under the mold closing pressure, and performing mold clamping by using an automatic control system, wherein the molding pressure is obtained based on the molding temperature and the temperature-pressure coupling relationship;
(7) performing the near-net-shape molding process at the molding pressure and the molding temperature; and simultaneously monitoring, by the temperature sensors and the first pressure sensors, the surfaces of the plurality of prepreg sections in contact with the cavity or the core of the cavity-core mold and the central position of the plurality of prepreg sections in real time, recording a temperature-time curve, and performing temperature adjustment in time such that temperature differentials between the central position and the surfaces of the plurality of prepreg sections in contact with the cavity or the core of the cavity-core mold are maintained within 3° C.; and monitoring the temperature-pressure coupling relationship at the same time; and
(8) after the near-net-shape molding process is performed for a molding time, performing demolding and post-processing to obtain the resin matrix composite part.

2. The method of claim 1, wherein characterization of the resin matrix, selection of a curing reaction model of the resin matrix and a length of a short-cut fiber of the short-cut fiber prepreg, and setting of temperature and pressure parameters are performed in the plastic molding simulation software.

3. The method of claim 1, wherein in step (1), the resin matrix of the short-cut fiber prepreg is selected from the group consisting of an epoxy resin, a phenolic resin, an unsaturated polyester resin, and a combination thereof; and
the short-cut fiber of the short-cut fiber prepreg is selected from the group consisting of a short-cut carbon fiber, a short-cut glass fiber, a short-cut aramid fiber, a short-cut basalt fiber, and a combination thereof.

4. The method of claim 1, wherein step (1) further comprises:
obtaining a gelation temperature, a curing temperature, and a curing time of the resin matrix of the short-cut fiber prepreg by testing;
wherein the gelation temperature, the curing temperature, and the curing time of the resin matrix are obtained using a differential scanning calorimeter, a rheometer, or a flat-plate microknife fiber drawing method; and
determining the molding temperature to be within a range from the curing temperature of the resin matrix to the curing temperature plus 20° C., and determining the curing time as the molding time.

5. The method of claim 1, wherein in step (2), the cavity-core mold is made of steel, aluminum alloy, or ceramic.

6. The method of claim 1, wherein the cavity-core mold is provided with a positioning pin, a second pressure sensor, and a displacement sensor; and
the positioning pin is configured to ensure thickness uniformity of the resin matrix composite part; the second pressure sensor is configured for real-time pressure monitoring within the cavity; and the displacement sensor is configured to monitor a mold closing position and a resin overflow amount in real time. 5

7. The method of claim 1, wherein in step (6), the mold closing pressure is 0.1-0.5 MPa.

8. The method of claim 1, wherein in step (4), the one of the plurality of prepreg sections corresponding to the portion of the resin matrix composite part with the largest cross-section is arranged equidistant from all edges of a cross-section of the cavity corresponding to the portion of the resin matrix composite part with the largest cross-section.
